(19) United States
(12) Patent Application Publication
(10) Pub. No.: US 2025/0337154 A1
(43) Pub. Date: Oct. 30, 2025

(54) INTEGRATED THREE-DIMENSIONAL RADIO FREQUENCY ANTENNA, RADIO FREQUENCY MODULE AND WIRELESS RADIO FREQUENCY-BASED COMMUNICATION DEVICE

(71) Applicant: SKYWORKS SOLUTIONS, INC., Irvine, CA (US)

(72) Inventor: Songbai Zhang, Singapore (SG)

(21) Appl. No.: 19/192,679

(22) Filed: Apr. 29, 2025

Related U.S. Application Data
(60) Provisional application No. 63/640,526, filed on Apr. 30, 2024.

(51) Int. Cl. H01Q 1/22; H01Q 1/48; H01Q 1/52; H01Q 13/02; H01Q 19/10

(52) U.S. Cl. CPC H01Q 1/2283; H01Q 1/48; H01Q 1/526; H01Q 13/02; H01Q 19/104

(57) ABSTRACT

Aspects and embodiments disclosed herein include an integrated 3-dimensional radio-frequency antenna, comprising a molded substrate having a front side surface, a back side surface, and at least one cavity extending completely from the front side surface to the back side surface, the at least one cavity defining cavity walls in the molded substrate with a horizontal profile of a cross-section of the at least one cavity vertically decreasing from the front side surface towards the back side surface, a shield layer covering at least the front side surface and the cavity walls of the molded substrate, and a radiator layer including an active side, a portion of the active side that emits RF waves or receives RF waves being exposed to the cavity of the molded structure.

### CROSS-REFERENCE TO RELATED APPLICATIONS

This application claims priority under 35 U.S.C. § 119(e) to U.S. Provisional Patent Application Ser. No. 63/640,526, titled “INTEGRATED THREE-DIMENSIONAL RADIO FREQUENCY ANTENNA, RADIO FREQUENCY MODULE AND WIRELESS RADIO FREQUENCY-BASED COMMUNICATION DEVICE,” filed Apr. 30, 2024, the entire content of which is incorporated herein by reference for all purposes.

### TECHNICAL FIELD

Aspects and embodiments disclosed herein relate to an integrated 3-dimensional radio-frequency (RF) antenna for transmitting and receiving RF signals. Aspects and embodiments disclosed herein further relate to an RF module and a wireless RF-based communication device.

### BACKGROUND

Antennas have experienced significant evolution since their inception, from large, bulky designs to compact chip antennas, with engineers constantly striving to miniaturize antennas. However, even these chip antennas have limitations in terms of performance and placement within electronic systems. In conventional 4G devices and applications in sub-6 GHz bands, antennas are typically manufactured as separate components. They are either printed on or are directly attached to a printed circuit board (PCB) in a specific configuration or assembled as a separate component with matching circuits near the RF front-end chip.

As a result, the so-called antenna-in-package (AiP) technology has become the primary method for packaging antennas in various RF applications. AiP technology denotes an antenna packaging solution that implements the integration of RF components, such as antennas and RF integrated circuits into a single integrated circuit package. The AiP technology enables a low-loss planar structure and low fabrication cost, streamlines wireless device design, reduces the need for external antennas and saves valuable space in compact devices.

However, antenna designs on a substrate within the meaning of the AiP technology frequently face the problem of significant insertion losses arising from the planar arrangement at radio wave frequencies. Thus, the hybrid integration of the antenna on an additional substrate is an alternative solution, which exploits AiP technology within such limited space. It often leads to an increase of the integration and packaging complexity, with the potential for performance degradation due to mutual coupling.

Therefore, the favorable trend toward front-end miniaturization and system integration in AiP technology poses a challenge for antenna integration without compromising its radiation efficiency, bandwidth, and achievable gain.

Another challenge with AiP solutions is electromagnetic interference (EMI) which causes mutual coupling and affects the proper operation of the antenna and radio-frequency integrated circuit (RFIC). In AiP solutions, EMI is mainly generated from the discontinuity of interconnection between the RFIC and antenna, the excitation and propagation of surface waves, and the antenna far-field radiation. The packaged antenna excites not only wanted space waves but also unwanted surface waves. The propagation of surface waves and backward radiation of both space and surface waves causes undesirable coupling between the antenna and the radio chip, thus degrading the performance of the wireless module.

Commonly known techniques used to reduce EMI are the use of differential antennas, air cavities and holes, guard rings, and fences of vias. From a conventional point of view, the most effective technique is to use a shielding can. Unfortunately, it is usually difficult for most printed-circuit technologies to realize such a can structure. More sophisticated techniques featuring an electromagnetic bandgap (EBG) structure show promising advance. However, an effective EBG structure takes up considerable space. Moreover, while techniques using guard rings and fences of vias are effective to improve the isolation and to reduce undesirable coupling in integrated circuit and package designs, this type of design requires following some complex calculations and design guidelines.

Usually, an antenna component consists of multiple conductive elements, for example metal rods in Yagi-Uda antennas, metal layers in patch antennas, or other specific shapes depending on the context of use. The primary type of conductive element, also known as the core of an antenna component, is called the “radiator.” The radiator refers to a driven element or an active element that is electrically connected to the receivers and/or transmitters. In an antenna in transmitting mode, it is driven or excited by the radio frequency current from the transmitter. In an antenna in receiving mode, it collects the incoming radio waves for reception.

Several other types of conductive elements, called parasitic elements, do not connect to the transmitters or receivers. Instead, the parasitic elements act as resonators and are coupled electromagnetically with the radiators and serve to modify the radiation pattern of the antenna, direct the radio waves in one direction and increase the gain of the antenna. The parasitic elements come in two types: a “reflector,” which reflects the radio waves in the opposite direction, and a “director,” which increases the radiation gain in a given direction. An antenna component may have one or more reflectors placed or attached on one side of the radiator, and one or more directors placed or attached on the other side of the radiator.

The gain of an antenna is one of the key performance parameters which combines the directivity and radiation efficiency of the antenna. In a transmitting mode antenna, the gain describes how well the antenna converts input power into RF waves headed in a specified direction. In a receiving mode antenna, the gain describes how well the antenna converts RF waves arriving from a specified direction into electrical power. When no direction is specified, gain is understood to refer to the peak value of the gain, which the gain is in the direction of the main lobe of the antenna. The gain of an antenna is defined as “the ratio of the radiation intensity in a given direction to the radiation intensity that would be produced if the power accepted by the antenna were isotropically radiated.”

### SUMMARY

According to a first aspect, the present disclosure provides an integrated 3-dimensional radio-frequency (RF) antenna. The integrated 3-dimensional RF antenna includes a molded substrate having a front side surface and a back side surface and at least one cavity extending completely from the front side surface to the back side surface. The at least one cavity defines cavity walls in the molded substrate, with a horizontal profile of a cross-section of the at least one cavity vertically decreasing from the front side surface towards the back side surface. The integrated 3-dimensional RF antenna further includes a shield layer covering the molded substrate at least at the front side surface and at the cavity walls. The integrated 3-dimensional RF antenna further includes a radiator layer having an active side, a portion of which emits RF waves or receives RF waves and is exposed to the at least one cavity of the molded structure.

According to a second aspect, the present disclosure provides a radio-frequency (RF) module. The RF module includes a printed circuit board (PCB), and at least one antenna-in-package (AiP) component arranged on or attached to the PCB. The AiP component includes at least one integrated 3-dimensional RF antenna that includes a molded substrate having a front side surface and a back side surface. The molded substrate includes at least one cavity extending completely from the front side surface to the back side surface and defining cavity walls in the molded substrate. A horizontal profile of a cross-section of the cavity is vertically decreasing from the front side surface towards the back side surface. The AiP component further includes a shield layer covering the molded substrate at least at the front side surface and at the cavity walls, a radiator layer which comprises an active side, wherein a portion of the active side that emits RF waves or receives RF waves is exposed to the at least one cavity of the molded structure.

According to a third aspect, the present disclosure provides a wireless radio-frequency (RF) based communication device, the wireless RF-based communication device comprising a housing with a printed circuit board (PCB), at least one processing unit which is configured to process received or to be transmitted communication information, and an RF module arranged in the housing. The RF module includes at least one antenna-in-package (AiP) component arranged on the PCB. The AiP component includes at least one integrated 3-dimensional RF antenna that includes a molded substrate having a front side surface and a back side surface. The molded substrate includes at least one cavity extending completely from the front side surface to the back side surface, and defining cavity walls in the molded substrate. A horizontal profile of a cross-section of the cavity is vertically decreasing from the front side surface towards the back side surface. A shield layer covers the molded substrate at least at the front side surface and at the cavity walls. A radiator layer includes an active side, with a portion of the active side that emits RF waves or receives RF waves being exposed to the at least one cavity of the molded substrate. At least one processing unit is configured to process received or to be transmitted communication information.

Aspects and embodiments disclosed herein provide an integrated 3-dimensional RF antenna, which is further applied to AiP solution. This antenna has generally higher gain compared to a 2-dimensional planar structure, facilitates easier design for antenna configuration with AiP solutions, reduces mutual coupling between the identical antenna components, and ensures crosstalk isolation from an active radio-frequency integrated circuit (RFIC).

Aspects and embodiments disclosed herein combine the benefits of a compact design with the capability to achieve higher gain. The use of a molded substrate with at least one cavity, where the horizontal profile of a cross-section gradually decreases vertically from the front side surface to the back side surface, provides a directional function, resulting in higher radiation gain. The thickness of the molded substrate may be enlarged or reduced when another resonant operating frequency is desired, as long as the thickness of the molded substrate is equal to or nearly equal to one-quarter wavelength of the electromagnetic wave at the resonance frequency. This 3-dimensional RF antenna is further applied to the antenna configuration with AiP solutions.

In aspects and embodiments disclosed herein, the use of a shield layer covering the molded substrate, at least at the front side surface and at the cavity walls, significantly simplifies both the antenna design in the AiP solution and the method to achieve reduced mutual coupling along the antenna array and crosstalk isolation with the RFIC. The shield layer is designed to not cover the active side of the radiator layer which is exposed to the cavity of the molded structure; otherwise, no RF waves will be emitted or received on the radiator layer. The conformal shielding replaces conventional “can” shielding with a lower cost, smaller footprint solution that provides more effective EMI shielding.

Advantageous configurations and developments emerge from the further dependent claims and from the description with reference to the figures of the drawings.

In at least one implementation of the integrated 3-dimensional RF antenna, the cavity walls in the molded substrate have a smooth, non-stepped surface. To form such cavity walls, a specific fabrication process is utilized. For example, the fabrication process may utilize a specialized mold for either transfer or injection molding. A mold is a hollow container used to give shape to molten or hot liquid material when it cools and hardens. Transfer molding is a technical process for the production of molded parts under the influence of pressure and heat. In transfer molding, a pre-measured amount of molding material, is placed into a “pot” or cavity in a molding machine. The material is then heated until it becomes molten. Once the material is in a molten state, a plunger forces the material into a closed mold containing the part to be molded. Pressure is applied so that the material fills all areas of the mold cavity. After the material has cooled and solidified, the mold is opened, and the fabrication process of the molded substrate is finished. Injection molding is a manufacturing process for producing parts by injecting molten material into a mold. In injection molding, material for the part is fed into a heated barrel, and injected into a mold cavity, where it cools and hardens to the configuration of the cavity. Other fabrication techniques for the shaping of cavities having smooth, non-stepped surfaces are possible as well. In some implementations, the cavity walls in the molded substrate form a smooth, non-stepped structure, which differs from a stepped profile corrugated structure used to create openings of different sizes in a multi-layered substrate to form a vertical hollow in the substrate.

In at least one implementation of the integrated 3-dimensional RF antenna, the cross-sectional profile of the cavity in the molded substrate in the vertical direction has a V-shape, U-shape, or trapezoidal shape. The profile of the cross-section of the cavity steadily decreases in the vertical direction, which means from the front side surface towards the back side surface of the molded substrate. The decrease may be regular or non-regular resulting in a V-shape or a curved shape. The shape of the cross-section provides a gradual transition structure to match the impedance of a transmitting or receiving path to the impedance of free space, enabling the RF waves from the transmitting or receiving path to radiate efficiently into space. Furthermore, this design also enables a larger aperture of the 3-dimensional antenna, allows it to capture more energy, and concentrates it into a narrower beam, resulting in higher gain.

In at least one implementation of the integrated 3-dimensional RF antenna, the antenna further includes a reflector layer which forms the reflector of the antenna and which is configured to reflect the RF waves and redirect RF energy in a desired direction. A reflector is an optional conductive element in the antenna structure, typically influencing the directivity of the antenna and the gain of the antenna. Additionally, the reflector layer can impede the propagation of surface waves, thereby improving crosstalk isolation and reducing mutual coupling. The reflector is typically positioned behind the driven element (radiator) opposite to the direction of desired radiation. When electromagnetic waves reach the reflector, they are redirected and reinforced in the intended direction, effectively increasing the gain of the antenna and improving its performance.

In at least one implementation of the integrated 3-dimensional RF antenna, the antenna includes a multi-layer structure. The multi-layer structure is composed of a plurality of different or similar layers. For example, the multi-layer structure may include a shield layer, a molded substrate, a radiator layer, a reflector layer, at least one ground layer, at least one routing layer, and/or at least one isolation layer. The shield layer is the layer that is mainly responsible for achieving reduced mutual coupling along the antenna arrays and providing crosstalk isolation between the antenna arrays and the RFIC. The molded substrate with at least one cavity extending completely from the front side surface to the back side surface provides a directional function, resulting in a higher radiation gain. The radiator layer is the “driven or active element” of this antenna component. It is electrically connected to the receivers or transmitters. In an antenna in transmitting mode, it is driven or excited by the RF current from the transmitter. In an antenna in receiving mode, it collects the incoming RF waves for reception. The reflector layer reflects the RF waves and redirects RF energy in a desired direction. In some implementations, the reflector layer is placed or attached on one side of the radiator layer, and the molded substrate is then placed or attached on the other side of the radiator layer.

The ground layer refers to a layer of conductive material that is electrically connected to the ground potential. It serves as a reference point for electrical signals within the package and provides a common ground reference for the components and interconnections within the package. The routing layer refers to a specific layer within the package where interconnections are routed to connect different components. The interconnections serve to transmit signals between various elements such as integrated circuits, dies, or other components within the package. The isolation layer can include a dielectric layer disposed between the radiator layer and the reflector layer. The multi-layer structure can further include a plurality of routing layers and/or isolation layers disposed between adjacent routing layers of the plurality of routing layers. The isolation layer is a layer or multiple layers of non-conductive materials that are used to electrically isolate different components, interconnections, and conductive traces within the package. These isolation layers serve several important functions within the package, such as electrical isolation, mechanical support, and thermal management. The materials of the isolation layers are chosen based on their dielectric properties, mechanical strength, thermal conductivity, and compatibility with the manufacturing processes involved in packaging. There may be multiple routing layers and/or isolation layers within the package. Additionally, in some embodiments, there is more than one ground layer within the package to achieve better signal integrity and enhanced thermal dissipation.

In at least one implementation of the integrated 3-dimensional RF antenna, a portion of the active side that emits RF waves or receives RF waves can be called an active portion. The active portion of the radiator layer is exposed to the cavity of the molded substrate and the portion of the radiator layer that is not exposed to the cavity of the molded substrate is directly attached to the back side surface of the molded structure. In some embodiments, there is no isolation layer between the molded substrate and the radiator layer, as the material of the molded substrate is often epoxy-based. Epoxy-based molded substrates are typically able to provide electrical insulation, thermal conductivity, and mechanical stability.

In at least one implementation of the integrated 3-dimensional RF antenna, there is at least one isolation layer arranged between the radiator layer and the reflector layer. Since the materials of the radiator layer and the reflector layer are often conductive, isolation is utilized between these two layers to prevent short circuits and crosstalk within the package.

In at least one implementation of the integrated 3-dimensional RF antenna, the ground layer can also serve as a reflector layer by including at least one cavity on the ground layer acting as a reflector. When the cavity is appropriately sized and arranged relative to the active portion of the radiator layer, it can effectively reflect and redirect RF waves, and thereby enhance the performance of the antenna by focusing radiation in a desired direction or pattern. Hence, a more compact design can be obtained.

In at least one implementation of the integrated 3-dimensional RF antenna, the active portion of the radiator layer that emits or receives RF waves can have a shape of a dipole, a folded quarter wavelength strip, a folded dipole, or a planar patch with a shape such as rectangular, circular, triangular, or an irregular sheet shape with slots. The active portion of the radiator layer may be a planar radiating portion in some implementations. It can be utilized for emitting or receiving RF waves. The directivity and the gain enhancement of the antenna can be achieved by the configuration of the molded substrate and the reflector layer. Therefore, the design of the integrated 3-dimensional antenna is simplified.

In at least one implementation of the integrated 3-dimensional RF antenna, at least one of the radiator layer, the reflector layer, or the ground layer is made of a conductive material. In some embodiments, the conductive material consists of or comprises copper, aluminum, silver, or any alloy thereof. In principle, the efficiency is closely linked to the conductivity of the material: for example, the higher the conductivity, the higher is the efficiency of the antenna. Therefore, it is desirable to choose antenna materials which offer very good—or at least good—conductivity in practice. Other considerations such as mechanical considerations (e.g., sustainability and mechanical/scratch stability), environmental considerations, cost considerations, weight considerations, and the like also play a role in antenna design. For example, copper, brass (copper-zinc alloy), bronze (copper-tin alloy), and aluminum are among widely used conducting materials to build antennas. Silver is also commonly used in antenna design due to its excellent electrical conductivity. Due to its cost, durability issues, and mechanical strength limitations, one potential solution to manufacture antennas is using a conductive layer composed of prepared silver nanoparticles.

In at least one implementation of the integrated 3-dimensional RF antenna, the shield layer is made of an EMI isolating material. The EMI isolating material may be selected for its ability to effectively block or attenuate electromagnetic interference. The EMI material may be or may include copper, copper ion ferrite plate, aluminum, nickel, or the like. The EMI isolating material may be chosen to provide high electrical conductivity while also offering excellent shielding effectiveness against external electromagnetic fields. Additionally, the EMI isolating material used in the shield layer should have such properties that allow for easy integration into the semiconductor package and compatibility with the manufacturing processes involved. This enables the shield layer to effectively isolate sensitive components from unwanted electromagnetic interference, thereby maintaining the integrity and reliability of the electronic device.

In at least one implementation of the integrated 3-dimensional RF antenna, the shield layer is a conformal shield layer. Conformal EMI shielding is an EMI shielding method applied directly to electronic packages to prevent electromagnetic interference in sensitive components. The conformal shield layer is applied in the form of thin metallic layers sputtered onto the molded substrate at least at the front side surface and at the cavity walls and then covering them. Alternatively, a conformal shield layer in the form of thin metallic layers on the front side surface of the molded structure and the walls of the cavity can be applied through painting, spraying, dispensing, electroplating, and the like. The thickness of the shielding layer may be approximately in the range of about 3 μm to about 250 μm. The conformal EMI shielding method is a low-cost, small footprint solution that provides effective EMI shielding.

In at least one implementation of the integrated 3-dimensional RF antenna, the integrated 3-dimensional RF antenna comprises at least one electrical connection between the shield layer and the ground layer. The at least one electrical connection may include conductive traces or vias, ensuring a low-impedance path for electrical current between the shield layer and the ground layer. By establishing this connection, induced or stray currents on the shield layer can be efficiently discharged to ground, maintaining the integrity of RF signals within the antenna.

In at least one implementation of the integrated 3-dimensional RF antenna, the shield layer and the ground layer are connected via capacitive coupling. Capacitive coupling between the shield layer and the ground layer may be established through the proximity of these two conductive elements without direct physical contact. This connection method utilizes the capacitance between the shield layer and the ground layer, allowing for the transfer of electrical signals while blocking the flow of direct current. By using capacitive coupling, the integrated 3-dimensional RF antenna may achieve effective grounding and EMI shielding. Additionally, this method offers advantages such as reduced complexity and size, making it suitable for compact and cost-effective antenna designs.

In at least one implementation of the integrated 3-dimensional RF antenna, a 3-dimensional antenna may be represented by a horn antenna or a parabolic antenna. A horn antenna is an antenna that consists of a horn-shaped waveguide that directs RF waves into a beam. It provides a gradual transition structure to match the impedance of a waveguide to the impedance of free space, enabling the RF waves from the waveguide to radiate efficiently into space. If two antennas have the same physical size without any other enhancements, a 3-dimensional antenna is expected to have higher gain compared to a planar antenna. An example of a planar antenna is a patch antenna. A patch antenna is characterized by its low profile, which can be mounted on a surface of a substrate. It typically consists of a planar rectangular, circular, triangular, or any geometrical sheet or “patch” of metal, mounted over a larger sheet of metal called a ground plane. 3-dimensional antennas typically have larger apertures and offer a more directive signal emitting characteristic compared to planar antennas. The larger aperture of a 3-dimensional antenna allows it to capture more energy and concentrate it into a narrower beam, resulting in higher gain. Planar antennas may not be able to capture and concentrate electromagnetic energy as efficiently as 3-dimensional antennas due to their less directive radiation patterns. Thus, planar antennas may exhibit lower gain than 3-dimensional antennas of comparable sizes.

In at least one implementation of the RF module, a plurality of AiP component arrays are arranged on the PCB. Each single AiP component may include at least one integrated 3-dimensional RF antenna and at least one integrated circuit arranged in the molded substrate. The integrated circuit includes at least one RFIC and/or other integrated circuit according to the context of use, such as a millimeter-wave transceiver integrated circuit or a baseband integrated circuit or the like. The integrated circuit is arranged in the molded substrate and electrically connected to the radiator layer using some support elements such as copper pillars, solder balls, solder bumps, and the like. Integrating the integrated circuit within the molded substrate allows for a compact and streamlined design, reducing the footprint of the RF module and minimizing signal loss between components. In certain implementations, there are also other RFICs arranged directly on the PCB.

In at least one implementation of the RF module, an AiP component array of a plurality of AiP component arrays is a multiple-input multiple-output (MIMO) system. The AiP component array may include at least one one-dimensional, two-dimensional, or three-dimensional array that contains a number of AiP components that are connected or interconnected with each other. The antenna gain is increasing with the addition of other AiP components. The MIMO system may be a 2×2 MIMO system, which means it comprises an array of 2×2 AiP components. The implemented architecture can be easily scaled to 4×4 system, which means it comprises an array of 4×4 AiP components. The 4×4 system may also be composed of four 2×2 MIMO systems. A 1×8 AiP component array can be integrated along the edge of a wireless communication device, enabling beamforming at various angles to deliver usable beams along the edges of devices. Three-dimensional AiP component arrays, such as a 4×2×4 configuration or a 4×4×4 antenna configuration, exhibit improved performance when employing joint beamforming techniques. This technique enables the simultaneous achievement of array gain and spatial diversity or multiplexing gain.

In at least one implementation, the integrated circuit of the RF module can include at least one of a transceiver, a logic control network, a switching network, and/or at least one signal processor component. The transceiver is configured to transmit or receive the RF signals. The logic control network is configured to provide logical control commands to the RF module. The switching networking is configured to select a distinctive signal transmitting path to realize half-duplex or full-duplex communication. A plurality of signal processor components may include low noise amplifiers (LNAs), bypass filters, and power amplifiers. The RF module can be a front end module. The RF front end module may include a bypass path. The switch can be configured to electrically connect the low noise amplifier and the integrated antenna component in a first state, and to electrically connect the bypass path and the integrated antenna component in a second state. The RF front end module can further include a power amplifier. The switch can be configured to electrically connect the power amplifier and the integrated antenna component in a third state. In certain implementations, the low noise amplifier and the power amplifier circuit are embodied on a single integrated circuit. The integrated circuit can be a semiconductor-on-insulator (SOI) integrated circuit.

In at least one implementation of the wireless RF-based communication device, the wireless communication device may include at least one of a central processing unit (CPU), a memory, a motherboard, or at least one screen attached to, at least partially embedded in, or arranged within an opening of the housing of the wireless RF-based communication device. The screen can be a touch screen. The at least one processing unit may include at least one of a central processing unit (CPU), at least one memory, or a motherboard.

Where appropriate, the above-mentioned configurations and developments can be combined with each other as desired, as far as this is reasonable. Further possible configurations, developments and implementations also include combinations, which are not explicitly mentioned, of features which have been described previously or are described in the following with reference to the configurations. In particular, in this case, a person skilled in the art will also assess individual aspects as improvements or supplements to the basic form of the present disclosure.

### BRIEF DESCRIPTION OF THE DRAWINGS

For a more comprehensive understanding of aspects and embodiments disclosed herein and the advantages thereof, exemplary configurations are explained in more detail in the following description with reference to the accompanying drawing figures, in which like reference characters designate like parts and in which:

FIG. 1 is a schematic diagram of an example of a communication network;

FIG. 2A is a schematic diagram of an example of a downlink channel using multi-input and multi-output (MIMO) communication;

FIG. 2B is a schematic diagram of an example of an uplink channel using MIMO communication;

FIG. 3A is a schematic block diagram of a front end module;

FIG. 3B is a schematic block diagram of another front end module;

FIG. 3C is a schematic block diagram of another front end module;

FIG. 4A is a schematic block diagram of a wireless communication device that includes an AiP component in accordance with some embodiments;

FIG. 4B is a schematic block diagram of another wireless communication device that includes an AiP component in accordance with some embodiments;

FIG. 5 is a cross-sectional view of single integrated 3-dimensional RF antenna using conformal shielding in accordance with some embodiments;

FIG. 6 is a cross-sectional view of an AiP component with integrated 3-dimensional RF antennas in accordance with some embodiments;

FIG. 7 is a top view of a RF module in 2×2 MIMO implementation in accordance with some embodiments; and

FIGS. 8A to 8E illustrate a fabrication process of an AiP component with integrated 3-dimensional RF antennas in accordance with some embodiments.

The appended drawings are intended to provide further understanding of the configurations disclosed herein. They illustrate configurations and, in conjunction with the description, help to explain principles and concepts disclosed herein. Other configurations and many of the advantages mentioned become apparent in view of the drawings. The elements in the drawings are not necessarily shown to scale.

In the drawings, like functionally equivalent and identically operating elements, features and components are provided with like reference signs, unless stated otherwise.

### DETAILED DESCRIPTION

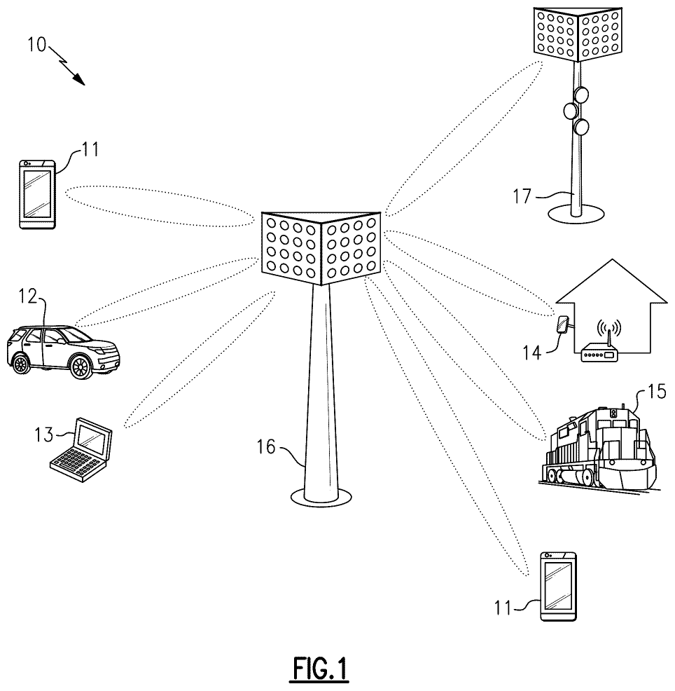

FIG. 1 illustrates a schematic diagram of an example of a communication network. The communication network in FIG. 1 is denoted by reference numeral 10. The communication network 10 shown in FIG. 1 includes a macro cell base station 16, a small cell base station 17, and various examples of different user equipment, UE, 11-15. The user equipment 11-15 may include mobile devices 11, a wireless-connected car 12, a laptop 13, a stationary wireless device 14, and a wireless-connected train 15. Although specific examples of base stations and UEs are illustrated in FIG. 1, a communication network can include base stations and UEs of a wide variety of types and/or numbers. For instance, in the example show in FIG. 1, the communication network 10 includes the macro cell base station 16 and the small cell base station 17. The small cell base station 17 can operate with relatively lower power, shorter range, and/or with fewer concurrent users relative to the macro cell base station 16. The small cell base station 17 can also be referred to as a femtocell, a picocell, or a microcell. Although the communication network 10 is illustrated as including two base stations, the communication network 10 can be implemented to include more or fewer base stations and/or base stations of other types.

The communication network 10 of FIG. 1 can be used to support a wide variety of advanced communication features, including, but not limited to, eMBB, uRLLC, and/or mMTC.

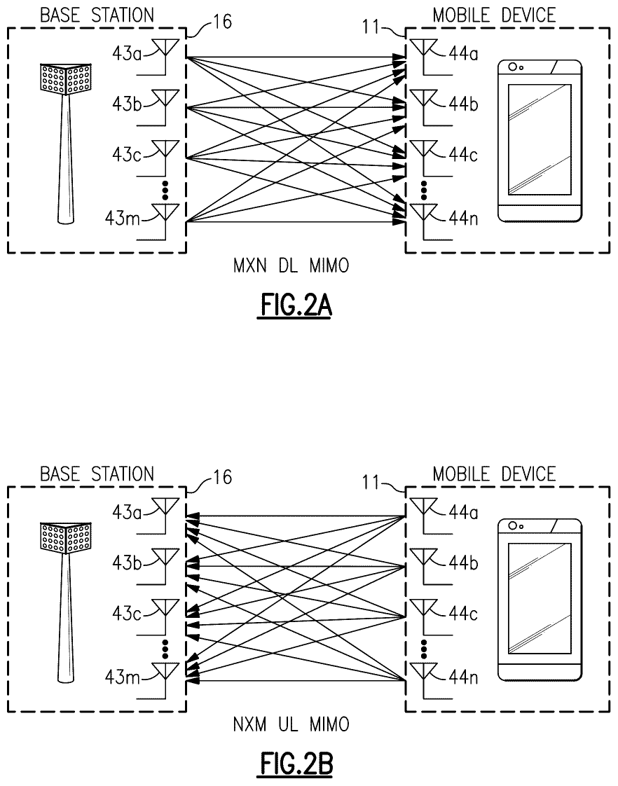

FIG. 2A is a schematic diagram of one example of a downlink channel using multi-input and multi-output, MIMO, communications.

In the example show in FIG. 2A, downlink MIMO communications are provided by transmitting using M antenna 43a, 43b, 43e, . . . 43m of the base station 16 and receiving using N antennas 44a, 44b, 44c, . . . , 44n of the mobile device 11. Accordingly. FIG. 2A illustrates an example of M×N DL MIMO.

MIMO communications use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two, 2×2, DL MIMO refers to MIMO downlink communications using two base station antennas and two user equipment, UE, antennas. Additionally, four-by-four, 4×4, DL MIMO refers to MIMO downlink communications using four base station antennas and four UE antennas. FIG. 2B is schematic diagram of one example of an uplink channel using MIMO communications.

In the example show in FIG. 2B, uplink MIMO communications are provided by transmitting using N antennas 44a, 44b, 44c, . . . 44n of the mobile device 11 and receiving using M antennas 43a, 43b, 43c, . . . 43m of the base station 16. Accordingly, FIG. 2B illustrates an example of N×M UL MIMO.

Likewise, MIMO order for uplink communications can be described by a number of transmit antenna of UE, such as a mobile device, and a number of receive antennas of a base station. For example, 2×2 UL MIMO refers to MIMO uplink communications using two UE antennas and two base station antennas. Additionally, 4×4 UL MIMO refers to MIMO uplink communications using four UE antennas and four base station antennas.

By increasing the level or order of MIMO, bandwidth of an uplink channel and/or a downlink channel can be increased.

MIMO communications are applicable to communication links of a variety of types, such as FDD communication links and TDD communication links.

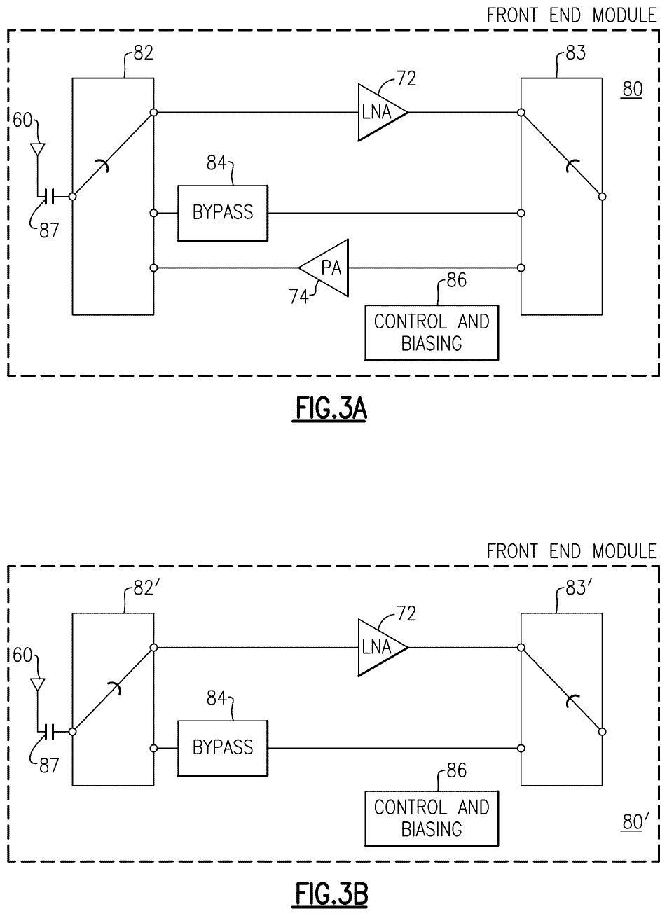

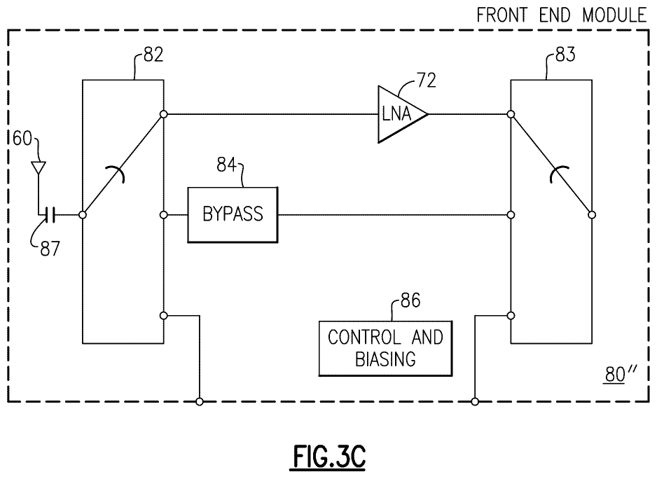

FIGS. 3A, 3B, and 3C are schematic block diagrams of front end modules with AiP component according to certain configurations. An RF front end can include circuits in a signal path between an antenna and a baseband system. Some RF front ends can include circuits in signal paths between one or more antennas and a mixer configured to modulate a signal to RF or to demodulate an RF signal.

FIG. 3A is a schematic block diagram of an RF front end module 80 according to a configuration. The RF front end module 80 is configured to receive RF signals from an AiP component 60 and to transmit RF signals by way of the AiP component 60. The AiP component 60 can be implemented in accordance with any of the principles and advantages discussed herein. The illustrated front end module 80 includes a first multi-throw switch 82, a second multi-throw switch 83, a receive signal path that includes an LNA 72, a bypass signal path that includes a bypass network 84, and a transmit signal path that includes a power amplifier 74. The low noise amplifier 72 can be any suitable low noise amplifier. The bypass network 84 can include any suitable network for matching and/or bypassing the receive signal path and the transmit signal path. The bypass network 84 can be implemented by a passive impedance network and/or by a conductive trace or wire. The power amplifier 74 can be implemented by any suitable power amplifier.

The LNA 72, the switches 82 and 83, and the power amplifier 74 can be shielded from the AiP component 60 by a shielding structure in accordance with any of the principles and advantages discussed herein.

The first multi-throw switch 82 can selectively electrically connect a particular signal path to the AiP component 60. The first multi-throw switch 82 can electrically connect the receive signal path to the AiP component 60 in a first state, electrically connect the bypass signal path to the AiP component 60 in a second state, and electrically connect the transmit signal path to the AiP component 60 in a third state. The AiP component 60 can be electrically connected to the switch 82 by way of a capacitor 87. The second multi-throw switch 83 can selectively electrically connect a particular signal path to an I/O port of the front end module 80, in which the particular signal path is the same signal path electrically connected to the AiP component 60 by way of the first multi-throw switch 82. Accordingly, the second multi-throw switch 83 together with the first multi-throw switch 82 can provide a signal path between the AiP component 60 and an I/O port of the front end module 80. A system on chip (SOC) can be electrically connected to the I/O port of the front end module 80.

The control and biasing block 86 can provide any suitable biasing and control signals to the other circuits of the front end module 80. For example, the control and biasing block 86 can provide bias signals to the LNA 72 and/or the power amplifier 74. Alternatively or additionally, the control and biasing block 86 can provide control signals to the multi-throw switches 82 and 83 to set the state of these switches.

FIG. 3B is a schematic block diagram of an RF front end module 80′ according to a configuration. The RF front end module 80′ of FIG. 3B is similar to the RF front end module 80 of FIG. 3A, except that a transmit signal path is omitted and the multi-throw switches 82′ and 83′ each have one fewer throw than corresponding multi-throw switches in the front end module 80 of FIG. 3A. The illustrated front end module 80′ includes a receive signal path and a bypass signal path, but does not include a transmit signal path.

FIG. 3C is a schematic block diagram of an RF front end module 80″ according to a configuration. The RF front end module 80″ of FIG. 3C is like the RF front end module 80 of FIG. 3A, except that a power amplifier of the transmit signal path is omitted from the RF front end module 80″. The RF front end module 80″ includes I/O ports for coupling to throws of the multi-throw switches 82 and 83. A power amplifier external to the front end module 80″ can be electrically connected between these I/O ports such that the power amplifier is included in the transmit signal path between the multi-throw switches 82 and 83. The power amplifier can be included in a different packaged module than the illustrated elements of the RF front end module 80″.

The front end modules of FIGS. 3A, 3B, and 3C can be packaged modules. Such packaged modules can include relatively low cost laminate based front end modules that combine low noise amplifiers with power noise amplifiers and/or RF switches in certain implementations. Some such packaged modules can be multi-chip modules. In the modules of FIGS. 3A, 3B, and 3C, an antenna is integrated with the RF front end. The integrated antenna of such RF front end modules can be implemented in accordance with any of the principles and advantages discussed herein. These RF front end modules can be antenna-in-package systems. The integrated antenna can be implemented in an antenna layer on a first side of a substrate that is shielded from the circuits of the RF front end on a second side of the substrate at least partly by a ground plane implemented in a layer of the substrate.

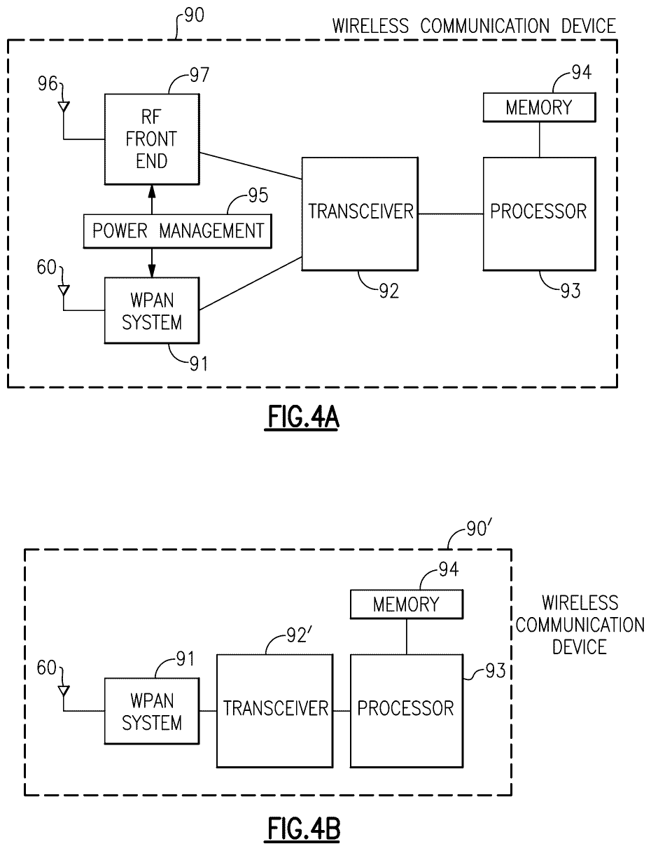

FIGS. 4A and 4B are schematic block diagrams of illustrative wireless RF-based communication devices that include a shielded package with AiP components in accordance with one or more configurations. The wireless communication device 90 of FIG. 4A can be any suitable wireless communication device. For instance, wireless communication device 90 can be a mobile phone such as a smart phone. As illustrated, the wireless communication device 90 includes an AiP component 60 integrated with a wireless personal area network (WPAN) system 91, a transceiver 92, a processor 93, a memory 94, a power management block 95, a second AiP component 96, and an RF front end system 97.

Any of the integrated antenna and shielding structures discussed herein can be implemented in connection with the WPAN system 91. The WPAN system 91 is an RF front end system configured for processing RF Signals associated with personal area networks (PANs). The WPAN system 91 can be configured to transmit and receive signals associated with one or more WPAN communication standards, such as signals associated with one or more of Bluetooth, ZigBee, Z-Wave, Wireless USB, INSTEON, IrDA, or Body Area Network. In another configuration, a wireless communication device can include a wireless local area network (WLAN) system in place of the illustrated WPAN System. Such a WLAN System can process Wi-Fi signals or other WLAN signals. Any of the integrated antenna and shielding structures discussed herein can be integrated with the RF front end system 97.

The illustrated wireless communication device 90′ of FIG. 4B is a device configured to communicate over a WPAN. The wireless communication device 90′ can be relatively less complex than the wireless communication device of FIG. 4A. As illustrated, the wireless communication device 90′ includes AiP components 60 integrated with a WPAN system 91, a transceiver 92′, a processor 93, and a memory 94. An integrated antenna and a shielding structure can be implemented in connection with the WPAN System 91 in accordance with any of the principles and advantages discussed herein. The wireless communication device 90′ can include a WLAN system in place of the illustrated WPAN system in another configuration. Such a WLAN system can process Wi-Fi signals or other WLAN signals.

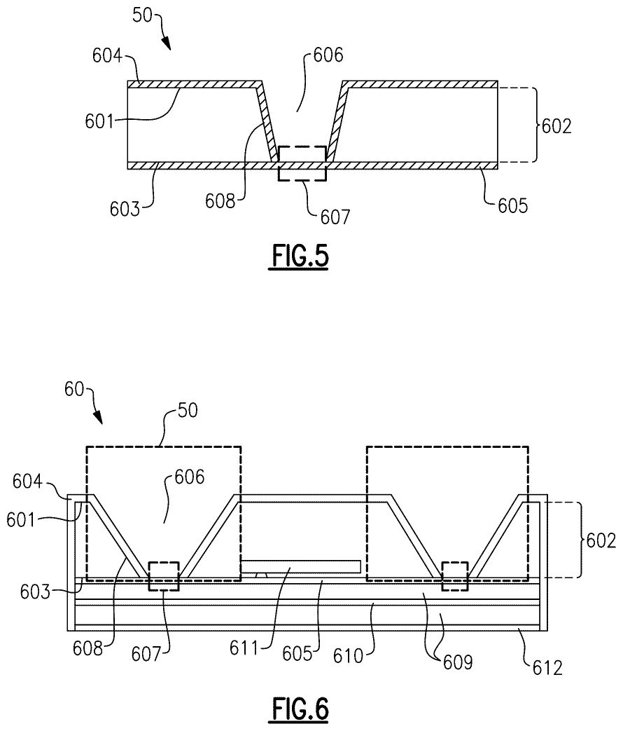

FIG. 5 illustrates a cross sectional view of an integrated 3-dimensional RF antenna 50 in accordance with one aspect. The integrated 3-dimensional RF antenna 50 includes a molded substrate 602, a shield layer 604, and a radiator layer 605. The molded substrate 602 comprises a front side surface 601, a back side surface 603, and at least one cavity 606. The radiator layer 605 includes an active portion 607 of the active side of the radiator layer 605.

The molded substrate 602 includes at least one cavity 606 extending completely from the front side surface 601 of the molded substrate 602 to the back side surface 603 of the molded substrate 602. The horizontal profile of a cross-section of the cavity 606 vertically decreases from the front side surface 601 towards the back side surface 603 of the molded substrate 602.

The shield layer 604 covers the molded substrate 602 at least at the front side surface 601 and at the cavity walls 608. The radiator layer 605 is directly attached to the back side surface 603 of the molded compound 602 and includes an active side, with an active portion 607 of the active side that emits RF waves or receives RF waves being exposed to the cavity 606 of the molded structure 602. The cavity walls 608 have smooth, non-stepped surfaces.

The use of the molded substrate 602 with at least one cavity 606, where the horizontal profile of a cross-section of the at least one cavity 606 gradually decreases vertically from the front side surface 601 to the back side surface 603 of the molded structure 602, provides a director function, resulting in higher radiation gain. The thickness of the molded substrate 602 may be enlarged or reduced when another resonant operating frequency is desired, such that the thickness of the molded substrate is equal to or nearly equal to one-quarter wavelength of the electromagnetic wave at the resonance frequency.

The use of a shield layer 604 covering at least at the front side surface 601 and the cavity walls 608 of the molded substrate 602 significantly simplifies both the antenna design in AiP solutions and the method to achieve reduced mutual coupling along the antenna array and crosstalk isolation with RFICs. In certain implementations, the shield layer 604 should not cover the active portion 607 of the radiator layer 605 which is exposed to the cavity 606 of the molded structure 602; otherwise, no RF waves will be emitted or received at the radiator layer 605. The conformal shielding replaces conventional “can” shielding with a lower cost, smaller footprint solution that provides more effective EMI shielding.

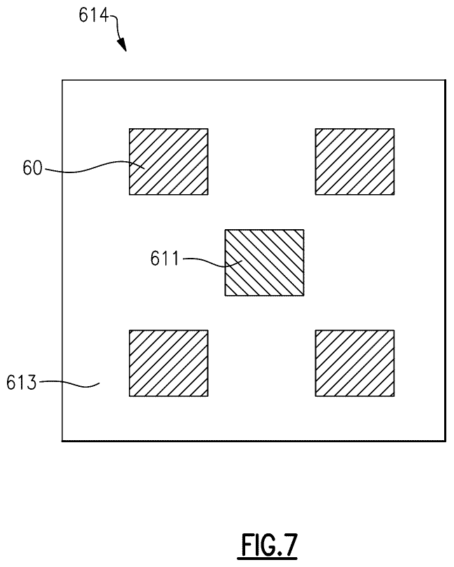

FIG. 6 illustrates a cross-sectional view of an AiP component 60 with integrated 3-dimensional RF antennas 50. In this configuration, there are two integrated 3-dimensional RF antennas 50 in the AiP component 60. Furthermore, an integrated circuit 611 is integrated in the molded substrate 602. The AiP component 60 further comprises a reflector layer 610 as a reflector of the antenna to reflect the RF waves and redirect RF energy in a desired direction, at least one isolation layer 609, and further layer 612, which can be a ground layer or a routing layer. The integrated circuit 611 comprises at least one RFIC and/or other integrated circuit according to the use of context, such as a millimeter-wave transceiver integrated circuit or a baseband integrated circuit or the like.

The reflector is an optional conductive element in the antenna structure, typically influencing the directivity of the antenna and the gain of the antenna. The reflector is typically positioned behind the driven element (the radiator) opposite to the direction of desired radiation. When electromagnetic waves reach the reflector, they are redirected and reinforced in the intended direction, effectively increasing the gain of the antenna and improving its performance.

In certain implementations, the reflector layer 610 is placed or arranged on one side of the radiator layer 605, and the molded substrate 602 is placed or arranged on the other side of the radiator layer 605.

The isolation layer 609 can include a dielectric layer disposed between the radiator layer 605 and the reflector layer 610. The multi-layer structure can further include a plurality of routing layers and isolation layers disposed between adjacent routing layers of the plurality of routing layers. The isolation layer refers to one or more layers of non-conductive materials that are used to electrically isolate different components, interconnections, and conductive traces within the package. These isolation layers 609 serve several important functions within the package, such as electrical isolation, mechanical support, and thermal management. The materials of the isolation layers are chosen based on their dielectric properties, mechanical strength, thermal conductivity, and compatibility with the manufacturing processes involved in packaging.

The active portion 607 of the radiator layer 605 is exposed to the cavity 606 of the molded substrate 602 and the portion of the radiator layer 605 that is not exposed to the cavity 606 of the molded substrate 602 is directly attached to the back side surface 603 the molded structure. There is no isolation layer 609 between the molded substrate 602 and the radiator layer 605, as the material of the molded substrate 602 is often epoxy-based, and it is able to provide electrical insulation, thermal conductivity, and mechanical stability.

The ground layer can also serve as a reflector layer 610, by including at least one cavity on the ground layer acting as a reflector. When the cavity is appropriately sized and arranged relative to the active portion 607 of the radiator layer 605, it can effectively reflect and redirect RF waves, enhancing the performance of the antenna by focusing radiation in a desired direction or pattern. Hence, a more compact design can be obtained.

The active portion 607 of the radiator layer 605 that emits or receives RF waves can have a shape of a dipole, a folded quarter wavelength strip, a folded dipole, or a planar patch with a shape such as rectangular, circular, triangular, or an irregular sheet shape with slots. The active portion 607 of the radiator layer 605 in various embodiments is a planar radiating portion. It can be utilized for emitting or receiving RF waves, and the directivity and the gain enhancement of the antenna can be achieved through the configuration and/or design of the molded substrate 602 and the reflector layer 610. Therefore, the design of the integrated 3-dimensional antenna is simplified.

The integrated circuit 611 is arranged in the molded substrate 602 and electrically connected to the radiator layer 605 using support elements such as copper pillars, solder balls, solder bumps, and the like. Integrating the integrated circuit within the molded substrate 602 allows for a compact and streamlined design, reducing the footprint of the RF module and minimizing signal loss between components.

FIG. 7 illustrates a top view of an RF module in a 2×2 MIMO implementation 614 in accordance with an aspect of the present disclosure.

This configuration is a 2×2 MIMO implementation 614 that comprises four AiP components 60 and one integrated circuit 611 arranged on a PCB 613. In this particular implementation, the integrated circuit 611 can either be integrated into the AiP components 60 or placed outside the AiP components 60, depending on the specific usage context.

The configuration of FIG. 7 may be used in wireless communication devices. The wireless communication devices can be implemented in or as part of various electronic devices. Examples of the electronic devices can include, but are not limited to, consumer electronic products, electronic test equipment, cellular communications infrastructure such as a base station, etc. More specific examples of the electronic devices can include, but are not limited to, a mobile phone such as a smart phone, a wearable computing device such as a smart watch or an ear piece, a telephone, a television, a computer monitor, a computer, a modem, a hand-held computer, a laptop computer, a table computer, a personal digital assistant, a microwave, a refrigerator, a vehicular electronic system such as an automotive electronics system, a stereo system, a DVD player, a CD player, a digital music player such as an MP3 player, a radio, a camcorder, a camera such as a digital camera, a portable memory chip, a washer, a dryer, a washer/dryer, peripheral devices, a clock, etc. Further, the electronic devices can include unfinished products.

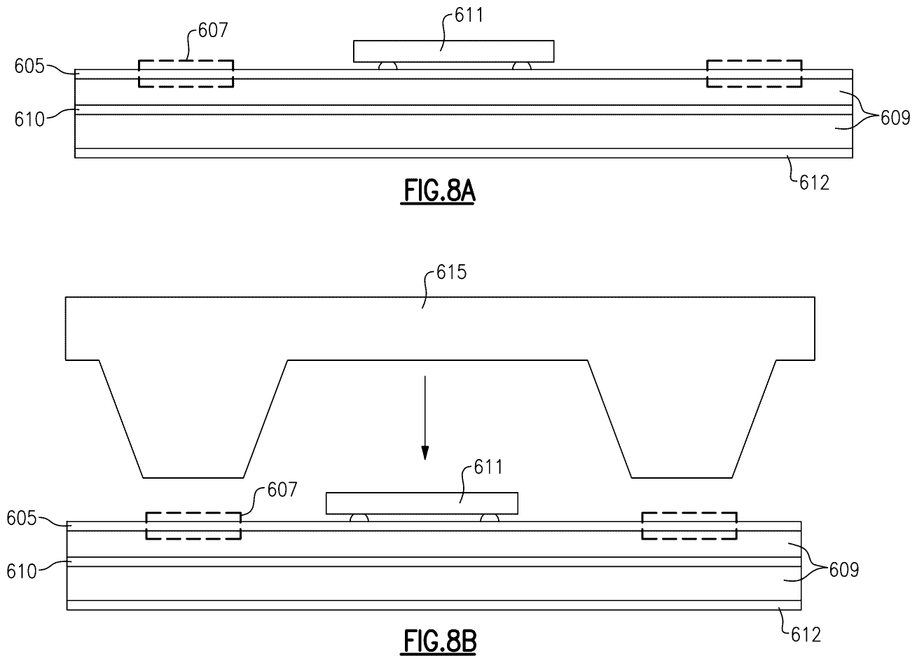

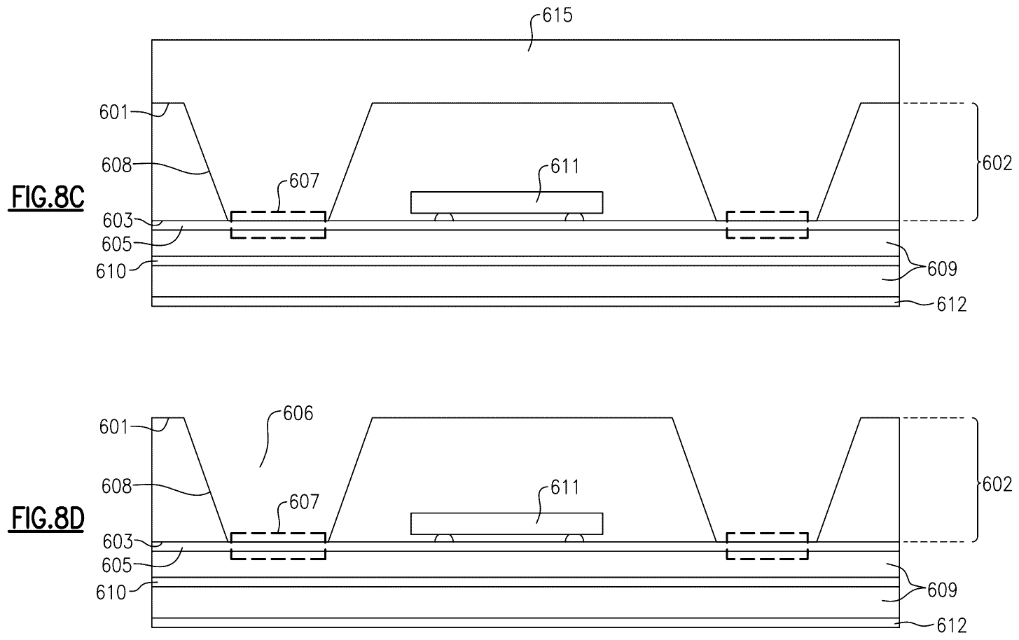

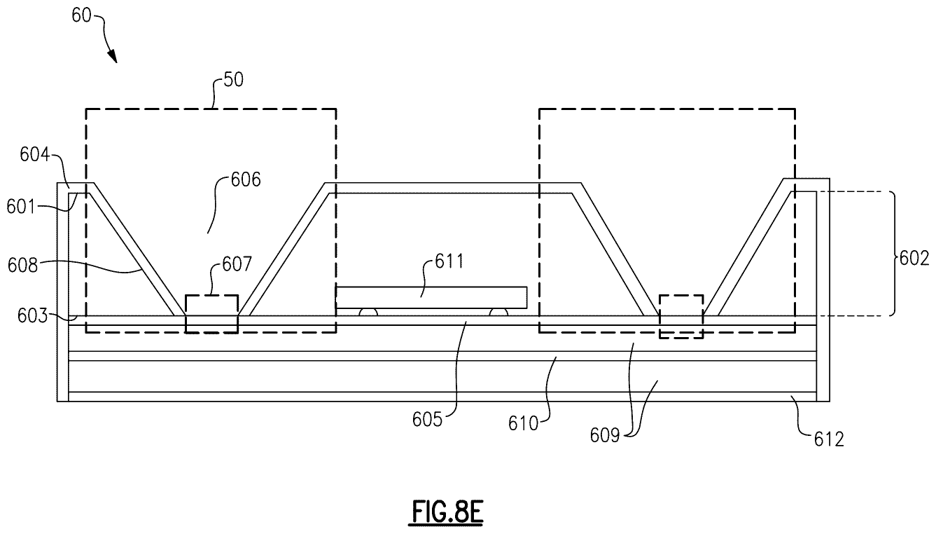

FIGS. 8A to 8E illustrate a fabrication process of an AiP component 60 with integrated 3-dimensional RF antennas 50. In the first step, as shown in FIG. 8A, a layer structure with a radiator layer 605 having active radiator positions 607, isolation layers 609 and a reflector layer 610 is formed. Additionally, there may be a layer 612 which could serve as a ground layer or as a routing layer. An RFIC 611 may be prepared in a flip-chip design during the first step.

In the second step, as shown in FIG. 8B, a special mold 615 for either transfer or injection molding is prepared.

In the third step, as shown in FIG. 8C, a pre-measured amount of molding material is transferred or injected into a “pot” or cavity in a molding machine to form the molded substrate 602.

In the fourth step, as shown in FIG. 8D, after the material has cooled and solidified the mold 615 is opened, and the fabrication process of the molded substrate 602 and the cavities 606 in the molded substrate 602 is finished.

In the last step, as shown in FIG. 8E, a conformal shield layer 604 is applied in the form of thin metallic layers on the front side surface 601 of the molded structure 602 and on the cavity walls 608. This process can be accomplished through sputtering, painting, spraying, dispensing, electroplating and the like. The thickness of the shielding layer 604 is approximately in the range of about 3 μm to about 250 μm in some embodiments. Thus, the conformal EMI shielding method is a low-cost, small footprint solution that provides effective EMI shielding.

Some of the configurations described above have provided examples in connection with RF components, front end modules, and/or wireless communications devices. However, the principles and advantages of the configurations can be used for any other systems or apparatus that could benefit from any of the circuits described herein. Although described in the context of RF circuits, one or more features described herein can also be utilized in packaging applications involving non-RF components. Similarly, one or more features described herein can also be utilized in packaging applications without the electromagnetic isolation functionality. Any of the principles and advantages of the configurations discussed can be used in any other systems or apparatus that could benefit from the antenna and/or the shielding structures discussed herein.

Unless the context clearly requires otherwise, throughout the description and the claims, the words “comprise,” “comprising,” “include,” “including,” and the like are to be constructed in an inclusive sense, as opposed to an exclusive or exhaustive sense; that is to say, in the sense of “including, but not limited to.” The word “arranged,” as generally used herein, refers to two or more elements that may be either directly connected, or connected by way of one or more intermediate elements. Likewise, the word “connected,” as generally used herein, refers to two or more elements that may be either directly connected, or connected by way of one or more intermediate elements. Additionally, the words “herein,” “above,” “below,” and words of similar import, when used in this application, refer to this application as a whole and not to any particular portions of this application. Where the context permits, words in the above detailed description of certain configurations using the singular or plural number may also include the plural or singular number, respectively. The word “or” in reference to a list of two or more items covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as,” and the like, unless specifically stated otherwise, or otherwise understood within the context as used, is generally intended to convey that certain configurations include, while other configurations do not include, certain features, elements and/or states. Thus, such conditional language is not generally intended to imply that features, elements and/or states are in any way required for one or more configurations or whether these features, elements and/or states are included or are to be performed in any particular configuration.

While certain configurations have been described, these configurations have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative configurations may perform similar functionalities with different components and/or circuit topologies, and same blocks may be deleted, moved, added, subdivided, combined, and/or modified. Each of these blocks may be implemented in a variety of different ways.

Any suitable combination of the elements and acts of the various configurations described above can be combined to provide further configurations. The accompanying claims and their equivalents are intended to cover such forms or modifications as would fall within the scope and spirit of the disclosure.

What is claimed is:

1. An integrated 3-dimensional radio-frequency (RF) antenna, comprising:
a molded substrate having a front side surface, a back side surface, and at least one cavity extending completely from the front side surface to the back side surface, the at least one cavity defining cavity walls in the molded substrate with a horizontal profile of a cross-section of the at least one cavity vertically decreasing from the front side surface towards the back side surface;
a shield layer covering at least the front side surface and the cavity walls of the molded substrate; and
a radiator layer including an active side, a portion of the active side that emits RF waves or receives RF waves being exposed to the at least one cavity of the molded structure.

2. The integrated 3-dimensional RF antenna of claim 1 wherein the cavity walls comprise a smooth, non-stepped surface.

3. The integrated 3-dimensional RF antenna of claim 1 further comprising a reflector layer configured to reflect the RF waves for redirecting RF energy.

4. The integrated 3-dimensional RF antenna of claim 1 wherein a portion of the radiator layer that is not exposed to the cavity in the molded structure is directly attached to the back side surface of the molded structure.

5. The integrated 3-dimensional RF antenna of claim 1 wherein the RF antenna has a multi-layer structure including at least one of at least one isolation layer that is made of electrically isolating material, a shield layer, a molded substrate, a radiator layer, a reflector layer, at least one ground layer, or at least one routing layer.

6. The integrated 3-dimensional RF antenna of claim 5 wherein at least one isolation layer is arranged between the radiator layer and the reflector layer.

7. The integrated 3-dimensional RF antenna of claim 6 wherein the reflector layer is the ground layer and includes at least one cavity acting as a reflector.

8. The integrated 3-dimensional RF antenna of claim 5 wherein the shield layer is made of an electromagnetic interference (EMI) isolating material.

9. The integrated 3-dimensional RF antenna of claim 5 wherein the shield layer is a conformal shield layer.

10. The integrated 3-dimensional RF antenna of claim 5 further comprising at least one electrical connection between the shield layer and the ground layer.

11. The integrated 3-dimensional RF antenna of claim 5 wherein the shield layer and the ground layer are connected via capacitive coupling.

12. The integrated 3-dimensional RF antenna of claim 1 wherein the portion of the active side of the radiator layer that emits or receives RF waves has a shape of at least one of a dipole, a folded dipole, or a planar rectangular, circular, or triangular patch.

13. The integrated 3-dimensional RF antenna of claim 1 wherein the RF antenna is a horn antenna.

14. A radio-frequency (RF) module, comprising:
a printed circuit board (PCB); and
at least one antenna-in-package (AiP) component arranged on or attached to the PCB, the AiP component including at least one integrated 3-dimensional RF antenna, the integrated 3-dimensional RF antenna including a molded substrate having a front side surface, a back side surface, and at least one cavity extending completely from the front side surface to the back side surface, the at least one cavity defining cavity walls in the molded substrate with a horizontal profile of a cross-section of the at least one cavity vertically decreasing from the front side surface towards the back side surface, a shield layer covering at least the front side surface and the cavity walls of the molded substrate, and a radiator layer including an active side, a portion of the active side that emits RF waves or receives RF waves being exposed to the at least one cavity of the molded structure.

15. The RF module of claim 14 further comprising at least one integrated circuit arranged within the molded substrate of the integrated 3-dimensional RF antenna and including at least one of a transceiver, a logic control network, a switching network, or at least one signal processor component.

16. The RF module of claim 14 wherein the at least one AiP component includes one of a one-dimensional, two-dimensional, or three-dimensional antenna array.

17. The RF module of claim 16 wherein the at least one AiP component is a multi-input multi-output (MIMO) system.

18. A wireless radio-frequency (RF) based communication device, comprising:
a housing with a printed circuit board (PCB);
at least one processing unit which is configured to process received or to be transmitted communication information; and
an RF module arranged in the housing, the RF module including at least one antenna-in-package (AiP) component arranged on or attached to the PCB, the at least one AiP component including at least one integrated 3-dimensional RF antenna, the integrated 3-dimensional RF antenna including a molded substrate having a front side surface, a back side surface, and at least one cavity extending completely from the front side surface to the back side surface, the at least one cavity defining cavity walls in the molded substrate with a horizontal profile of a cross-section of the at least one cavity vertically decreasing from the front side surface towards the back side surface, a shield layer covering at least the front side surface and the cavity walls of the molded substrate, and a radiator layer including an active side, a portion of the active side that emits RF waves or receives RF waves being exposed to the at least one cavity of the molded structure.

19. The wireless RF-based communication device of claim 18 further comprising at least one screen arranged within an opening of the housing.

20. The wireless RF-based communication device of claim 18 wherein the at least one processing unit includes at least one of a central processing unit (CPU), at least one memory, or a motherboard.
